(19) United States
(12) Patent Application Publication
(10) Pub. No.: US 2025/0063410 A1
(43) Pub. Date: Feb. 20, 2025

(54) MEASUREMENT METHOD AND APPARATUS, AND DEVICE AND READABLE STORAGE MEDIUM

(71) Applicant: Beijing Xiaomi Mobile Software Co., Ltd., Beijing (CN)

(72) Inventor: Xuhua TAO, Beijing (CN)

(21) Appl. No.: 18/721,324

(22) PCT Filed: Dec. 20, 2021
(86) PCT No.: PCT/CN2021/139811

§ 371 Date: Jun. 18, 2024

(51) Int. Cl. H04W 24/10; H04B 17/318; H04L 5/00; H04W 8/22; H04W 72/231

(52) U.S. Cl. CPC H04W 24/10; H04B 17/328; H04L 5/0051; H04W 8/22; H04W 72/231

(57) ABSTRACT

A measurement method is performed by a user equipment, and includes: sending capability indication information to a network device, wherein the capability indication information indicates at least one of a reception capability or a measurement capability; and receiving measurement configuration information, wherein the measurement configuration information is determined by the network device based on the capability indication information and indicates configuration information for the user equipment to measure a Sounding Reference Signal (SRS) of an interferer device.

### CROSS REFERENCE TO RELATED APPLICATION

The present application is a U.S. National Stage of International Application No. PCT/CN2021/139811, filed on Dec. 20, 2021, the content of which is incorporated herein by reference in its entirety.

### TECHNICAL FIELD

The present disclosure relates to the wireless communication technical field, and in particular to a measurement method and apparatus and a readable storage medium.

### BACKGROUND

In wireless communication technologies, such as the fifth generation mobile communication technology (5G), Cross Link Interference (CLI) may occur between User Equipments (UEs) that perform communications (including sending and/or receiving) simultaneously according to different scheduling commands on the same Time Division Duplex (TDD) carrier.

### SUMMARY

In view of above, the present disclosure provides a measurement method and apparatus and a readable storage medium.

According to a first aspect, there is provided a measurement method, performed by a user equipment, the method including:
sending capability indication information to a network device, wherein the capability indication information indicates a reception capability and/or a measurement capability; and
receiving measurement configuration information from the network device, wherein the measurement configuration information is determined by the network device based on the capability indication information and indicates configuration information for the user equipment to measure a Sounding Reference Signal (SRS) of an interferer device.

According to a second aspect, there is provided a measurement method, performed by a network device, the method including:
receiving capability indication information sent by a user equipment, wherein the capability indication information indicates a reception capability and/or a measurement capability;
determining measurement configuration information based on the capability indication information; and
sending the measurement configuration information to the user equipment, wherein the measurement configuration information indicates configuration information for the user equipment to measure a Sounding Reference Signal (SRS) of an interferer device.

According to a third aspect, there is provided a communication apparatus, including a processor and a memory. The memory is configured to store computer programs. The processor is configured to execute the computer programs to implement the method according to the first aspect.

According to a fourth aspect, there is provided a communication apparatus, including a processor and a memory. The memory is configured to store computer programs. The processor is configured to execute the computer programs to implement the method according to the second aspect.

According to a fifth aspect, there is provided a computer-readable storage medium. Instructions (or referred to as computer programs, or programs) are stored in the computer-readable storage medium. When the instructions are invoked and executed on a computer, the computer is caused to perform the method in the first aspect.

According to a sixth aspect, there is provided a computer-readable storage medium. Instructions (or referred to as computer programs, or programs) are stored in the computer-readable storage medium. When the instructions are invoked and executed on a computer, the computer is caused to perform the method in the second aspect.

It is to be understood that the foregoing general description and the following detailed description are exemplary and explanatory only and are not restrictive of the present disclosure.

### BRIEF DESCRIPTION OF THE DRAWINGS

The drawings described here are used to provide a further understanding of the embodiments of the present disclosure and constitute a part of this application. The example embodiments of the present disclosure and their descriptions are used to explain the embodiments of the present disclosure and do not constitute an undue limitation on the embodiments of the present disclosure.

The accompanying drawings, which are incorporated in and constitute a part of this specification, illustrate embodiments consistent with embodiments of the disclosure and together with the specification, serve to explain principles of embodiments of the disclosure.

FIG. 1 is a schematic diagram of a wireless communication system architecture provided by an embodiment of the present disclosure;

FIG. 2 is a flowchart of a measurement method according to an example embodiment;

FIG. 3 is a flowchart of a measurement method according to an example embodiment;

FIG. 4 is a flowchart of a measurement method according to an example embodiment;

FIG. 5 is a flowchart of a measurement method according to an example embodiment;

FIG. 6 is a flowchart of a measurement method according to an example embodiment;

FIG. 7 is a flowchart of a measurement method according to an example embodiment;

FIG. 8 is a structural diagram of a measurement apparatus according to an example embodiment;

FIG. 9 is a structural diagram of a measurement apparatus according to an example embodiment;

FIG. 10 is a structural diagram of a measurement apparatus according to an example embodiment;

FIG. 11 is a structural diagram of a measurement apparatus according to an example embodiment.

### DETAILED DESCRIPTION

The embodiments of the present disclosure will now be further described with reference to the accompanying drawings and example implementations.

Example embodiments will be described in detail herein, examples of which are illustrated in the accompanying drawings. When the following description refers to the drawings, the same numbers in different drawings refer to the same or similar elements unless otherwise indicated. The implementations described in the following example embodiments do not represent all implementations consistent with embodiments of the present disclosure. Rather, they are merely examples of apparatuses and methods consistent with some aspects of the present disclosure as detailed in the appended claims.

To mitigate the CLI, a UE measures CLI-Received Signal Strength Indication (CLI-RSSI) and/or Sounding Reference Signal-Reference Signal Receiving Power (SRS-RSRP) of an uplink sounding reference signal.

For example, a group of aggressor UEs send data on the same TTD carrier, while another group of victim UEs receive data on the same TTD carrier. After measuring SRS-RSRP and/or CLI-RSSI, a UE reports a measurement result. A network device (e.g., gNB) may evaluate the interference of an aggressor UE to a victim UE based on the measurement result. The aggressor UE sends an SRS signal on a set configuration, and the victim UE performs interference measurement of the SRS signal on the corresponding configuration.

Therefore, during measurement of SRS-RSRP and/or CLI-RSSI by a UE, issues such as service scheduling of a serving cell and UE measurement behavior(s) need to be solved.

As shown in FIG. 1, a measurement method provided by an embodiment of the present disclosure may be applied to a wireless communication system 100. The wireless communication system 100 may include but is not limited to a network device 101 and a user equipment 102. The user equipment 102 is configured to support carrier aggregation, and the user equipment 102 may be connected to a plurality of carrier units of the network device 101, including a primary carrier unit and one or more secondary carrier units.

It should be understood that the above wireless communication system 100 may be applied to both a low-frequency scenario and a high-frequency scenario. Application scenarios of the wireless communication system 100 include but are not limited to: a Long Term Evolution (LTE) system, a LTE Frequency Division Duplex (FDD) system, a LTE Time Division Duplex (TDD) system, a Worldwide interoperability for micro wave access (WiMAX) communication system, a Cloud Radio Access Network (CRAN) system, a future 5th-generation (5G) system, a New Radio (NR) communication system or a future evolved Public Land Mobile Network (PLMN) system, etc.

The user equipment 102 shown above may be a User Equipment (UE), a terminal, an access terminal, a terminal unit, a terminal station, a Mobile Station (MS), a remote station, a remote terminal, a mobile terminal, a wireless communication device, a terminal agent or a user device, etc. The user equipment 102 may have a wireless transceiving function, and the user equipment 102 can perform communication (such as wireless communication) with one or more network devices 101 of one or more communication systems, and accept network services provided by the one or more network devices 101. Here, a network device 101 includes but is not limited to a base station shown in the figure.

The user equipment 102 may be a cellular phone, a cordless phone, a Session Initiation Protocol (SIP) phone, a Wireless Local Loop (WLL) station, a Personal Digital Assistant (PDA) device, a handheld device with a wireless communication function, a computing device or other processing device connected to a wireless modem, a vehicle-mounted device, a wearable device, a user equipment in a future 5G network, or a user equipment in a future evolved PLMN network, etc.

The network device 101 may be an access network device (or access network point). The access network device refers to a device that provides a network access function, such as a Radio Access Network (RAN) base station, etc. The network device may specifically include a base station (BS) device, or include a base station device and a wireless resource management device for controlling the base station device, etc. The network device may further include a relay station (relay device), an access point, a base station in a future 5G network, a base station in a future evolved PLMN network, or an NR base station, etc. The network device may be a wearable device or a vehicle-mounted device. The network device may also be a communication chip having a communication module.

For example, the network device 101 includes but is not limited to: a next generation base station (gnodeB, gNB) in 5G, an evolved node B (eNB) in the LTE system, a Radio Network Controller (RNC), a Node B (NB) in the WCDMA system, a wireless controller under the CRAN system, a Base Station Controller (BSC), a Base Transceiver Station (BTS) in the GSM system or the CDMA system, a home base station (for example, home evolved nodeB, or home node B, HNB), a Baseband Unit (BBU), a Transmitting and Receiving Point (TRP), a Transmitting Point (TP) or a mobile switching center, etc.

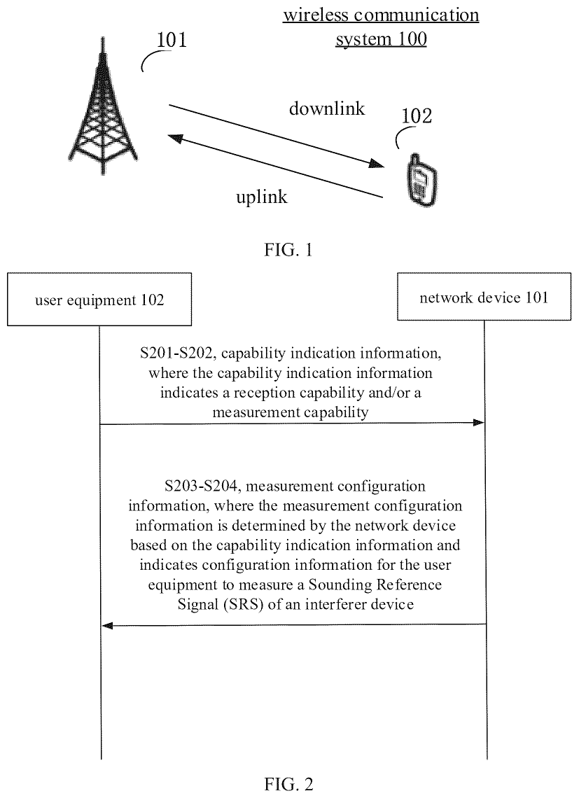

An embodiment of the present disclosure provides a measurement method. FIG. 2 is a flowchart of a measurement method according to an example embodiment. As shown in FIG. 2, the method includes the following steps:
In step S201, a user equipment 102 sends capability indication information to a network device 101. The capability indication information indicates a reception capability and/or a measurement capability.
In step S202, the network device 101 receives the capability indication information sent by the user equipment 102.
In step S203, the network device 101 sends measurement configuration information to the user equipment 102. The measurement configuration information is configuration information which is determined by the network device based on the capability indication information and is used for measuring a Sounding Reference Signal (SRS) of an interferer device.
In step S204, the user equipment 102 receives the measurement configuration information sent by the network device 101.

In the present disclosure, the user equipment timely reports the capability indication information including a reception capability and/or a measurement capability to the network device, so that the network device allocates reasonable scheduling and configuration to the user equipment according to the capability of the user equipment, thereby improving the processing capability of the user equipment.

In an implementation, the capability indication information indicates a reception capability and/or a measurement capability.

In the embodiments of the present disclosure, the user equipment timely reports the capability indication information including a reception capability and/or a measurement capability to the network device, so that the network device allocates reasonable scheduling and configuration to the user equipment according to the capability (capabilities) of the user equipment, improving the processing capability of the user equipment.

An embodiment of the present disclosure provides a measurement method, which is performed by a user equipment. FIG. 3 is a flowchart of a measurement method according to an example embodiment. As shown in FIG. 3, this method includes the following steps:
In step S301, capability indication information is sent to a network device. The capability indication information indicates a reception capability and/or a measurement capability.
In step S302, measurement configuration information is received from the network device. The measurement configuration information is determined by the network device based on the capability indication information and indicates configuration information for the user equipment to measure the Sounding Reference Signal (SRS) of the interferer device.

In an implementation, measuring the SRS of the interferer device includes: measuring SRS-RSRP and/or CLI-RSSI of the interferer device.

In an implementation, the capability indication information includes first information. The first information is: when Subcarrier Spacing (SCS) of a Physical Downlink Channel (PDCH) configured by a serving cell of the user equipment is different from Subcarrier Spacing (SCS) of the Sounding Reference Signal (SRS) of the interferer device, whether it is supported to simultaneously receive the PDCH and measure the SRS of the interferer device.

In an implementation, the first information is capability indication information which indicates the reception capability in the capability indication information.

In an implementation, when the first information corresponds to that it is supported to simultaneously receive the PDCH and measure the SRS of the interferer device, the network device schedules the Physical Downlink Channel (PDCH) during a measurement time period for the user equipment to measure the Sounding Reference Signal (SRS) of the interferer device.

In an implementation, when the first information corresponds to that it is not supported to simultaneously receive the PDCH and measure the SRS of the interferer device, the network device does not schedule the Physical Downlink Channel PDCH during the measurement time period for the user equipment to measure the Sounding Reference Signal (SRS) of the interferer device.

In an implementation, when the first information corresponds to that it is not supported to simultaneously receive the PDCH and measure the SRS of the interferer device, the network device does not schedule the Physical Downlink Channel (PDCH) during an extended time period of the measurement time period for the user equipment to measure the Sounding Reference Signal (SRS) of the interferer device. In one example, the extended time period of the measurement time period is a time domain region from N symbols before the measurement time period to M symbols after the measurement time period, and the N and the M are the same or different.

In an implementation, the capability indication information includes second information. The second information is whether a measurement gap is supported. The measurement gap is used to measure the SRS of the interferer device. When the second information corresponds to that the measurement gap is supported and the Sounding Reference Signal (SRS) of the interferer device is not within an active BWP of the serving cell, the network device sends measurement configuration information including measurement gap configuration information. The measurement gap configuration information indicates the measurement gap used when measuring the SRS of the interferer device. When the second information corresponds to that the measurement gap is not supported, the network device sends the measurement configuration information not including the measurement gap configuration information, that is, regardless of whether the SRS of the interferer device is within the active BWP of the serving cell, the measurement GAP is not configured for the user equipment. When the SRS of the interferer device is within the active BWP of the serving cell, the UE may measure the SRS of the interferer device without using the measurement gap, and when the SRS of the interferer device is not within the active BWP of the serving cell, the UE needs to use the measurement gap to measure the SRS of the interferer device.

An embodiment of the present disclosure provides a measurement method, which is performed by a user equipment. This method includes:
sending capability indication information to a network device, where the capability indication information indicates a reception capability; and
receiving measurement configuration information from the network device, where the measurement configuration information is determined by the network device based on the capability indication information and is used to indicate configuration information for the user equipment to measure the Sounding Reference Signal (SRS) of the interferer device.

In an implementation, measuring the SRS of the interferer device includes: measuring SRS-RSRP and/or CLI-RSSI of the interferer device.

In an implementation, the capability indication information includes first information. The first information is: when Subcarrier Spacing (SCS) of the Physical Downlink Channel (PDCH) configured by a serving cell of the user equipment is different from Subcarrier Spacing (SCS) of the Sounding Reference Signal (SRS) of the interferer device, whether it is supported to simultaneously receive the PDCH and measure the SRS of the interferer device.

In an implementation, the first information is capability indication information which indicates a reception capability in the capability indication information.

In an implementation, when the first information corresponds to that it is supported to simultaneously receive the PDCH and measure the SRS of the interferer device, the network device schedules the Physical Downlink Channel (PDCH) during a measurement time period for the user equipment to measure the Sounding Reference Signal (SRS) of the interferer device.

In an implementation, when the first information corresponds to that whether it is not supported to simultaneously receive the PDCH and measure the SRS of the interferer device, the network device does not schedule the Physical Downlink Channel (PDCH) during the measurement time period for the user equipment to measure the Sounding Reference Signal (SRS) of the interferer device.

In an implementation, when the first information corresponds to that it is not supported to simultaneously receive the PDCH and measure the SRS of the interferer device, the network device does not schedule the Physical Downlink Channel (PDCH) during an extended time period of the measurement time period for the user equipment to measure the Sounding Reference Signal (SRS) of the interferer device. In one example, the extended time period of the measurement time period is a time domain area from N symbols before the measurement time period to M symbols after the measurement time period, and the N and the M are the same or different.

An embodiment of the present disclosure provides a measurement method, which is performed by a user equipment. The method includes:
sending capability indication information to a network device, where the capability indication information indicates a measurement capability; and
receiving measurement configuration information from the network device, where the measurement configuration information is determined by the network device based on the capability indication information and indicates configuration information for the user equipment to measure a Sounding Reference Signal (SRS) of an interferer device.

In an implementation, measuring the SRS of the interferer device includes: measuring SRS-RSRP and/or CLI-RSSI of the interferer device.

In an implementation, the capability indication information includes second information. The second information is: whether a measurement gap is supported. The measurement gap is used to measure the SRS of the interferer device. When the second information corresponds to that the measurement gap is supported and the Sounding Reference Signal (SRS) of the interferer device is not within the active BWP of the serving cell, the network device sends measurement configuration information including measurement gap configuration information. The measurement gap configuration information is used to indicate a measurement gap used when measuring the SRS of the interferer device. When the second information corresponds to that the measurement gap is not supported, the network device sends measurement configuration information not including the measurement gap configuration information, that is, regardless of whether the SRS of the interferer device is within the active BWP of the serving cell, the measurement GAP is not configured for the user equipment. When the SRS of the interferer device is within the activate BWP of the serving cell, the UE may measure the SRS of the interferer device without using the measurement gap, and when the SRS of the interferer device is not within the active BWP of the serving cell, the UE needs to use the measurement gap to measure the SRS of the interferer device.

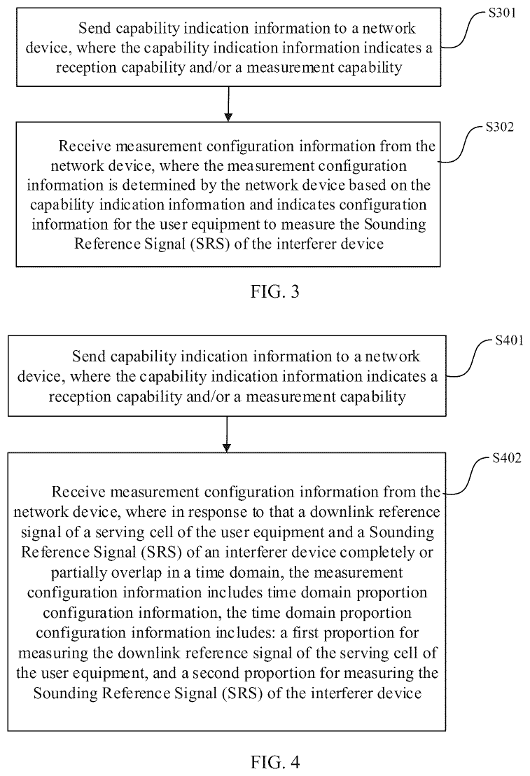

An embodiment of the present disclosure provides a measurement method, which is performed by a user equipment. FIG. 4 is a flowchart of a measurement method according to an example embodiment. As shown in FIG. 4, this method includes the following steps:
In step S401, capability indication information is sent to a network device, where the capability indication information indicates a reception capability and/or a measurement capability.
In step S402, measurement configuration information is received from the network device, wherein in response to that a downlink reference signal of a serving cell of the user equipment and a Sounding Reference Signal (SRS) of an interferer device completely or partially overlap in a time domain, the measurement configuration information includes time domain proportion configuration information. The time domain proportion configuration information includes: a first proportion for measuring the downlink reference signal of the serving cell of the user equipment, and a second proportion for measuring the Sounding Reference Signal (SRS) of the interferer device.

In an implementation, a sum of the first proportion and the second proportion is 1.

An embodiment of the present disclosure provides a measurement method, which is performed by a user equipment. FIG. 4 is a flowchart of a measurement method according to an example embodiment. As shown in FIG. 4, this method includes the following steps:
In step S401, capability indication information is sent to a network device, where the capability indication information indicates a reception capability and/or a measurement capability.
In step S402, measurement configuration information is received from the network device, where in response to that a downlink reference signal of a serving cell of the user equipment and a Sounding Reference Signal (SRS) of the interferer device completely or partially overlap in a time domain, the measurement configuration information includes information which indicates prioritized measurement of the downlink reference signal of the serving cell of the user equipment in a preset time period, or the measurement configuration information includes information which indicates prioritized measurement of the SRS of the interferer device in a preset time period, or in an implementation, the measurement configuration information includes priority indication information. The priority indication information indicates a priority of the downlink reference signal of the serving cell of the user equipment and a priority of the SRS of the interferer device, so that the user equipment preferentially measures a reference signal corresponding to the highest priority in the priority indication information in a preset time period.

In one example, the measurement configuration information further includes the preset time period, and the priorities in the priority indication information are used in the preset time period. For example: in a preset time period T, if the priority of the downlink reference signal of the serving cell is higher than the priority of the SRS of the interferer device, the UE preferentially measures the downlink reference signal of the serving cell; otherwise, the UE preferentially measures the SRS of the interferer device.

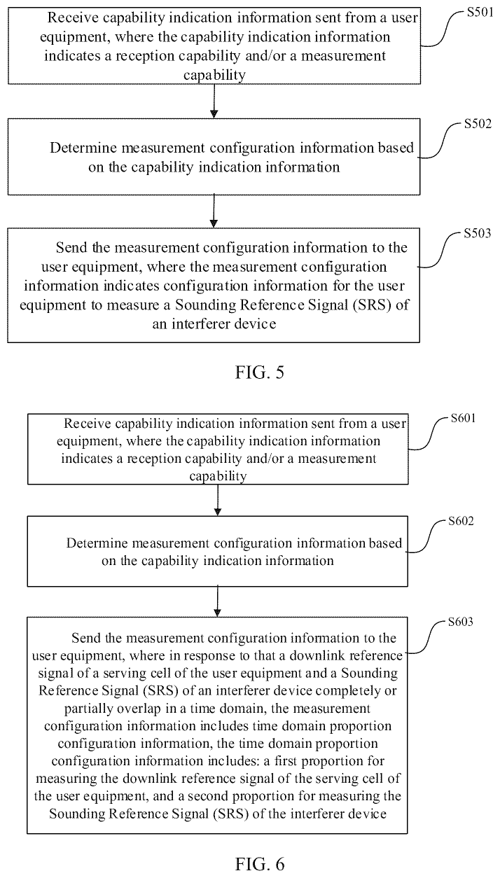

An embodiment of the present disclosure provides a measurement method, which is performed by a network device. FIG. 5 is a flowchart of a measurement method according to an example embodiment. As shown in FIG. 5, the method includes the following steps:
In step S501, capability indication information sent from a user equipment is received. The capability indication information indicates a reception capability and/or a measurement capability.
In step S502, measurement configuration information is determined based on the capability indication information.
In step S503, the measurement configuration information is sent to the user equipment. The measurement configuration information indicates configuration information for the user equipment to measure a Sounding Reference Signal (SRS) of an interferer device.

In an implementation, measuring the SRS of the interferer device includes: measuring SRS-RSRP and/or CLI-RSSI of the interferer device.

In an implementation, the capability indication information includes first information. The first information is: when Subcarrier Spacing (SCS) of a Physical Downlink Channel (PDCH) configured by a serving cell of the user equipment is different from Subcarrier Spacing (SCS) of the Sounding Reference Signal (SRS) of the interferer device, whether it is supported to simultaneously receive the PDCH and measure the SRS of the interferer device.

In an implementation, the first information is capability indication information used to indicate reception capability among the capability indication information.

In an implementation, in response to that the first information corresponding to that it is supported to simultaneously receive the PDCH and measure the SRS of the interferer device, the Physical Downlink Channel (PDCH) is scheduled during a measurement time period for the user equipment to measure the Sounding Reference Signal (SRS) of the interferer device.

In an implementation, in response to that the first information corresponding to that it is not supported to simultaneously receive the PDCH and measure the SRS of the interferer device, the Physical Downlink Channel (PDCH) is not scheduled during a measurement time period for the user equipment to measure the Sounding Reference Signal (SRS) of the interferer device.

In an implementation, in response to that the first information corresponds to that it is not supported to simultaneously receive the PDCH and measure the SRS of the interferer device, the Physical Downlink Channel (PDCH) is not scheduled during an extended time period of a measurement time period for the user equipment to measure the Sounding Reference Signal (SRS) of the interferer device. In an example, the extended time period is a time domain region from N symbols before the measurement time period to M symbols after the measurement time period, and the N and the M are the same or different.

In an implementation, when the first information corresponds to that it is not supported to simultaneously receive the PDCH and measure the SRS of the interferer device, the network device does not schedule the Physical Downlink Channel (PDCH) during the extended time period of the measurement time period during which the user equipment measures the Sounding Reference Signal (SRS) of the interferer device. In one example, the extended time period of the measurement time period is a time domain region from N symbols before the measurement time period to M symbols after the measurement time period, and the N and the M are the same or different.

In an implementation, the capability indication information includes second information. The second information is: whether a measurement gap is supported. The measurement gap is used to measure the SRS of the interferer device. In one example, in response to that the second information corresponds to that the measurement gap is supported and the Sounding Reference Signal (SRS) of the interferer device is not within an active BWP of the serving cell, the measurement configuration information includes measurement gap configuration information. The measurement gap configuration information indicates the measurement gap used when measuring the SRS of the interferer device. In one example, in response to the second information corresponding to that the measurement gap is not supported, the measurement configuration information does not include the measurement gap configuration information, that is, regardless of whether the SRS of the interferer device is within the active BWP of the serving cell, the measurement GAP is not configured for the user equipment. When the SRS of the interferer device is within the active BWP of the serving cell, the UE may measure the SRS of the interferer device without using the measurement gap, and when the SRS of the interferer device is not within the active BWP of the serving cell, the UE needs to use the measurement gap to measure the SRS of the interferer device.

An embodiment of the present disclosure provides a measurement method, which is performed by a network device. FIG. 6 is a flowchart of a measurement method according to an example embodiment. As shown in FIG. 6, the method includes the following steps:
In step S601, capability indication information sent from a user equipment is received. The capability indication information indicates a reception capability and/or a measurement capability.
In step S602, measurement configuration information is determined based on the capability indication information.
In step S603, the measurement configuration information is sent to the user equipment. In response to that a downlink reference signal of a serving cell of the user equipment and a Sounding Reference Signal (SRS) of an interferer device completely or partially overlap in a time domain, the measurement configuration information includes time domain proportion configuration information. The time domain proportion configuration information includes: a first proportion for measuring the downlink reference signal of the serving cell of the user equipment, and a second proportion for measuring the Sounding Reference Signal (SRS) of the interferer device.

In an example, a sum of the first proportion and the second proportion is 1.

In an implementation, measuring the SRS of the interferer device includes: measuring SRS-RSRP and/or CLI-RSSI of the interferer device.

An embodiment of the present disclosure provides a measurement method, which is performed by a network device. FIG. 7 is a flowchart of a measurement method according to an example embodiment. As shown in FIG. 7, this method includes the following steps:
In step S701, capability indication information sent from a user equipment is received. The capability indication information indicates a reception capability and/or a measurement capability.
In step S702, measurement configuration information is determined based on the capability indication information.
In step S703, in response to that a downlink reference signal of a serving cell of the user equipment and a Sounding Reference Signal (SRS) of the interferer device completely or partially overlap in a time domain, measurement configuration information is sent to the user equipment. The measurement configuration information includes information which indicates prioritized measurement of the downlink reference signal of the serving cell of the user equipment in a preset time period (in other words, the information indicates that measurement of the downlink reference signal of the serving cell of the user equipment is prioritized over measurement of the measurement of the SRS in the preset time period); or, the measurement configuration information includes information which indicates prioritized measurement of the SRS of the interferer device in a preset time period (in other words, the information indicates that measurement of the SRS is prioritized over measurement of the downlink reference signal of the serving cell of the user equiopment in the preset time period); or, the measurement configuration information includes priority indication information; where the priority indication information indicates a priority of the downlink reference signal of the serving cell of the user equipment and a priority of the SRS of the interferer device.

The user equipment preferentially measures a reference signal corresponding to the highest priority in the priority indication information in a preset time period.

In an implementation, the measuring the SRS of the interferer device includes: measuring SRS-RSRP and/or CLI-RSSI of the interferer device.

Based on the same concept as the above method embodiments, embodiments of the present disclosure further provide a communication apparatus. The communication apparatus may have the functions of the user equipment 101 in the above method embodiments, and may be configured to perform the steps performed by the user equipment 101 provided in the above method embodiments. The functions may be implemented by hardware, or by software or hardware executing corresponding software. The hardware or software includes one or more modules corresponding to the above functions.

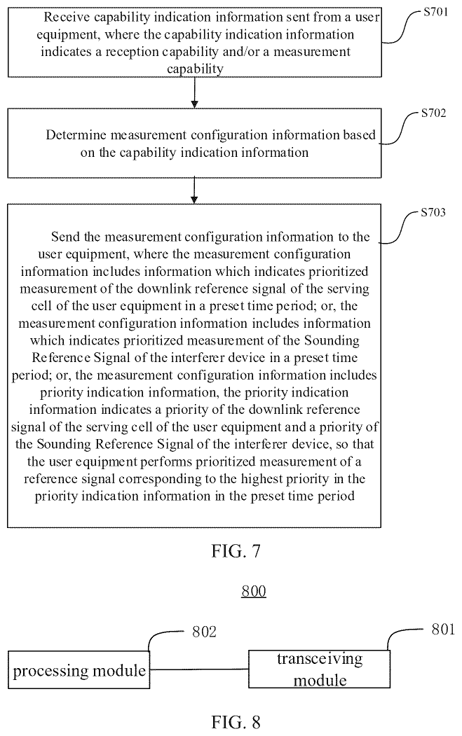

In an implementation, the communication apparatus 800 shown in FIG. 8 may serve as the user equipment involved in the above method embodiments, and may perform the steps performed by the user equipment in the above method embodiments. As shown in FIG. 8, the communication apparatus 800 may include a transceiving module 801 and a processing module 802. The transceiving module 801 and the processing module 802 are coupled to each other. The transceiving module 801 may be used to support the communication apparatus 800 to perform communications. The transceiving module 801 may have a wireless communication function, for example, it can conduct wireless communications with other communication apparatuses through a wireless air interface. The processing module 802 may be configured to support the communication apparatus 800 to perform the processing actions in the above method embodiments, including but not limited to: generating information or message(s) to be sent by the transceiving module 801, and/or performing demodulation and/or decoding on a signal received by the transceiving module 801, etc.

When performing the steps implemented by the user equipment 101, the transceiving module 801 is configured to send capability indication information to a network device. The capability indication information indicates a reception capability and/or a measurement capability. The transceiving module 801 is further configured to receive measurement configuration information from the network device. The measurement configuration information is determined by the network device based on the capability indication information and indicates configuration information for the user equipment to measure a Sounding Reference Signal (SRS) of an interferer device.

In an implementation, the capability indication information includes first information. The first information is: when Subcarrier Spacing (SCS) of a Physical Downlink Channel (PDCH) configured by a serving cell of the user equipment is different from Subcarrier Spacing (SCS) of the Sounding Reference Signal (SRS), whether it is supported to simultaneously receive the PDCH and measure the SRS of the interferer device.

In an implementation, the capability indication information includes second information. The second information is: whether a measurement gap is supported. The measurement gap is used to measure the SRS of the interferer device.

In an implementation, in response to that the second information corresponds to that the measurement gap is supported and the Sounding Reference Signal (SRS) of the interferer device is not within an active BWP of the serving cell, the measurement configuration information includes measurement gap configuration information. The measurement gap configuration information indicates the measurement gap used when measuring the SRS of the interferer device. The processing module 802 is configured to measure the SRS of the interferer device using the measurement gap.

In an implementation, in response to that a downlink reference signal of a serving cell of the user equipment and the Sounding Reference Signal (SRS) of the interferer device completely or partially overlap in a time domain, the measurement configuration information includes time domain proportion configuration information. The time domain proportion configuration information includes: a first proportion for measuring the downlink reference signal of the serving cell of the user equipment and a second proportion for measuring the Sounding Reference Signal (SRS) of the interferer device. The processing module 802 is configured to measure the downlink reference signal of the serving cell of the user equipment using the fist proportion and measure the Sounding Reference Signal (SRS) of the interferer device using the second proportion.

In an implementation, the sum of the first proportion and the second proportion is 1.

In an implementation, the measurement configuration information includes information which indicates prioritized measurement of the downlink reference signal of the serving cell of the user equipment in a preset time period. The processing module 802 is configured to perform prioritized measurement of the downlink reference signal of the serving cell of the user equipment within the preset time period.

In an implementation, the measurement configuration information includes information which indicates prioritized measurement of the SRS of the interferer device in a preset time period. The processing module 802 is configured to perform prioritized measurement of the SRS of the interferer device within the preset time period.

In an implementation, the measurement configuration information includes priority indication information. The priority indication information indicates a priority of the downlink reference signal of the serving cell of the user equipment and a priority of the detection reference signal of the interference device. The processing module 802 is configured to perform prioritized measurement of a reference signal corresponding to the highest priority in the priority indication information within the preset time period.

In an implementation, the processing module 802 is configured to measure SRS-RSRP and/or CLI-RSSI of the interferer device.

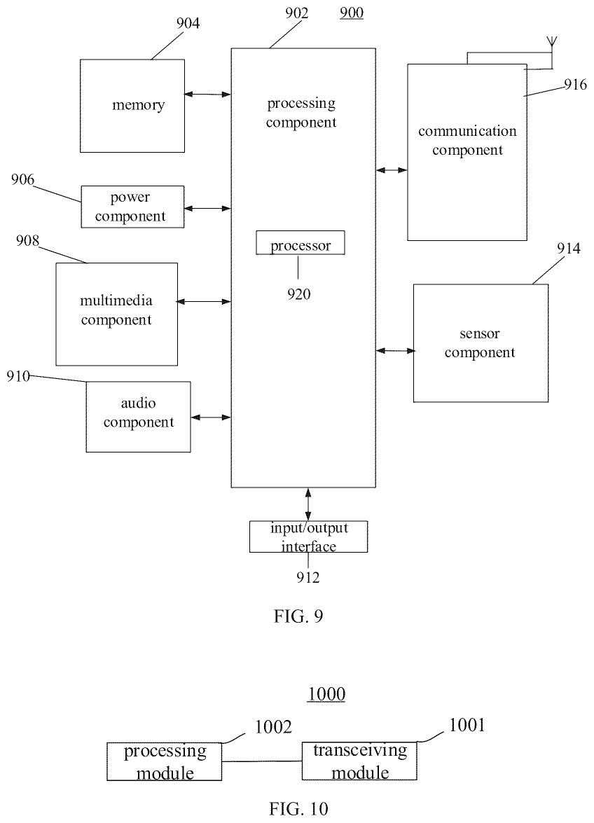

When the communication apparatus is the user equipment 102, its structure may also be as shown in FIG. 9. Referring to FIG. 9, the apparatus 900 may include one or more of the following components: a processing component 901, a memory 904, a power component 906, a multimedia component 908, an audio component 910, an input/output (I/O) interface 912, a sensor component 914, and a communication component 916.

The processing component 902 typically controls overall operations of the apparatus 900, such as the operations associated with display, telephone calls, data communications, camera operations, and recording operations. The processing component 902 may include one or more processors 920 to execute instructions to perform all or part of the steps in the above described methods. Moreover, the processing component 902 may include one or more modules which facilitate the interaction between the processing component 902 and other components. For instance, the processing component 902 may include a multimedia module to facilitate the interaction between the multimedia component 908 and the processing component 902.

The memory 904 is configured to store various types of data to support the operation of the apparatus 900. Examples of such data include instructions for any applications or methods operated on the apparatus 900. contact data, phonebook data, messages, pictures, video, etc. The memory 904 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 906 provides power to various components of the apparatus 900. The power component 906 may include a power management system, one or more power sources, and any other components associated with the generation, management, and distribution of power in the apparatus 900.

The multimedia component 908 includes a screen providing an output interface between the apparatus 900 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 908 includes a front camera and/or a rear camera. The front camera and the rear camera may receive an external multimedia datum while the apparatus 900 is in an operation mode, such as a photographing mode or a video mode. Each of the front camera and the rear camera may be a fixed optical lens system or have focus and optical zoom capability.

The audio component 910 is configured to output and/or input audio signals. For example, the audio component 910 includes a microphone (“MIC”) configured to receive an external audio signal when the apparatus 900 is in an operation mode, such as a call mode, a recording mode, and a voice recognition mode. The received audio signal may be further stored in the memory 904 or transmitted via the communication component 916. In some embodiments, the audio component 910 further includes a speaker to output audio signals.

The I/O interface 912 provides an interface between the processing component 902 and peripheral interface modules, such as a keyboard, a click wheel, buttons, and the like. The buttons may include, but are not limited to, a home button, a volume button, a starting button, and a locking button.

The sensor component 914 includes one or more sensors to provide status assessments of various aspects of the apparatus 900. For instance, the sensor component 914 may detect an open/closed status of the apparatus 900, relative positioning of components, e.g., the display and the keypad, of the apparatus 900, a change in position of the apparatus 900 or a component of the apparatus 900, a presence or absence of user contact with the apparatus 900, an orientation or an acceleration/deceleration of the apparatus 900, and a change in temperature of the apparatus 900. The sensor component 914 may include a proximity sensor configured to detect the presence of nearby objects without any physical contact. The sensor component 914 may also include a light sensor, such as a CMOS or CCD image sensor, for use in imaging applications. In some embodiments, the sensor component 914 may also include an accelerometer sensor, a gyroscope sensor, a magnetic sensor, a pressure sensor, or a temperature sensor.

The communication component 916 is configured to facilitate communication, wired or wirelessly, between the apparatus 900 and other devices. The apparatus 900 can access a wireless network based on a communication standard, such as WiFi, 4G, or 5G, or a combination thereof. In one example embodiment, the communication component 916 receives a broadcast signal or broadcast associated information from an external broadcast management system via a broadcast channel. In one example embodiment, the communication component 916 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In example embodiments, the apparatus 900 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In example embodiments. there is also provided a non-transitory computer-readable storage medium including instructions, such as the memory 904 including instructions executable by the processor 920 in the apparatus 900, for performing the above-described methods. For example, the non-transitory computer-readable storage medium may be a ROM, a Random Access Memory (RAM), a CD-ROM, a magnetic tape, a floppy disc, an optical data storage device, and the like.

Based on the same concept as the above method embodiments, embodiments of the present application also provide a communication apparatus. The communication apparatus may have the functions of the network device 102 in the above method embodiments, and may be used to perform the steps performed by the network device 102 in the above method embodiments. The functions may be implemented by hardware, or by software or hardware executing corresponding software. The hardware or software includes one or more modules corresponding to the above functions.

In an implementation, the communication apparatus 1000 shown in FIG. 10 may serve as the network device involved in the above method embodiments, and perform the steps performed by the network device in the above method embodiments. As shown in FIG. 10, the communication apparatus 1000 may include a transceiving module 1001 and a processing module 1002. The transceiving module 1001 and the processing module 1002 are coupled to each other. The transceiving module 1001 may be used to support the communication apparatus 300 to perform communications. The transceiving module 1001 may have a wireless communication function, for example, it can conduct wireless communications with other communication apparatuses through a wireless air interface. The processing module 1002 may be used to support the communication apparatus 1000 to perform the processing actions in the above method embodiments, including but not limited to: generating information or message(s) to be sent by the transceiving module 1001, and/or, performing demodulation and/or decoding on a signal received by the transceiving module 1001, etc.

When performing the steps implemented by the network device 102, the transceiving module 1001 is configured to receive capability indication information sent by a user equipment. The capability indication information indicates a reception capability and/or a measurement capability.

The processing module 1002 is configured to determine measurement configuration information based on the capability indication information.

The transceiving module 1001 is configured to send the measurement configuration information to the user equipment. The measurement configuration information indicates configuration information for the user equipment to measure a Sounding Reference Signal (SRS) of an interferer device.

In an implementation, the capability indication information includes first information. The first information is: when Subcarrier Spacing (SCS) of a Physical Downlink Channel (PDCH) configured by a serving cell of the user equipment is different from Subcarrier Spacing (SCS) of the Sounding Reference Signal (SRS) of the interferer device, whether it is supported to simultaneously receive the PDCH and measure the SRS of the interferer device.

In an implementation, the processing module 1002 is configured to, in response to that the first information corresponds to that it is supported to simultaneously receive the PDCH and measure the SRS of the interferer device, schedule the Physical Downlink Channel (PDCH) during a measurement time period for the user equipment to measure the Sounding Reference Signal (SRS) of the interferer device.

In an implementation, the processing module 1002 is configured to, in response to that the first information corresponds to that it is not supported to simultaneously receive the PDCH and measure the SRS of the interferer device, not schedule the Physical Downlink Channel (PDCH) during a measurement time period for the user equipment to measure the Sounding Reference Signal (SRS) of the interferer device.

In an implementation, the processing module 1002 is configured to, in response to that the first information corresponds to that it is not supported to simultaneously receive the PDCH and measure the SRS of the interferer device, not schedule the Physical Downlink Channel (PDCH) during an extended time period of a measurement time period for the user equipment to measure the Sounding Reference Signal (SRS) of the interferer device.

In an implementation, the extended time period is a time domain region from N symbols before the measurement time period to M symbols after the measurement time period, and the N and the M are the same or different.

In an implementation, the capability indication information includes second information. The second information is: whether a measurement gap is supported. The measurement gap is used to measure the SRS of the interferer device.

In an implementation, in response to that the second information corresponds to that the measurement gap is supported and the Sounding Reference Signal (SRS) of the interferer device is not within an active BWP of the serving cell, the measurement configuration information includes measurement gap configuration Information, where the measurement gap configuration information indicates the measurement gap used when measuring the SRS of the interferer device; or
in response to that the second information corresponds to that the measurement gap is not supported, the measurement configuration information does not include measurement gap configuration information.

In an implementation, in response to that a downlink reference signal of the serving cell of the user equipment and the Sounding Reference Signal (SRS) of the interferer device completely or partially overlap in a time domain, the measurement configuration information includes time domain proportion configuration information. The time domain proportion configuration information includes: a first proportion for measuring the downlink reference signal of the serving cell of the user equipment and a second proportion for measuring the Sounding Reference Signal (SRS) of the interferer device.

In an implementation, the sum of the first proportion and the second proportion is 1.

In an implementation, the measurement configuration information includes: information which indicates prioritized measurement of the downlink reference signal of the serving cell of the user equipment in a preset time period.

In an implementation, the measurement configuration information includes: information which indicates prioritized measurement of the SRS of the interferer device in a preset time period.

In an implementation, the measurement configuration information includes: a priority of the downlink reference signal of the serving cell of the user equipment and a priority of the SRS of the interferer device, so that the user equipment prioritizes measurement of a reference signal corresponding to the highest priority in the priority indication information.

In an implementation, the processing module 1002 is also configured to measure SRS-RSRP and/or CLI-RSSI of the interferer device.

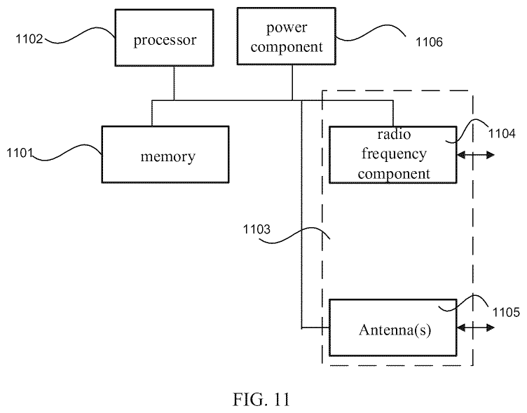

When the communication apparatus is a network device 102, its structure may also be as shown in FIG. 11. Taking a base station as an example to illustrate the structure of the communication apparatus. As shown in FIG. 11, the apparatus 1100 includes a memory 1101, a processor 1102, a transceiving component 1103, and a power component 1106. The memory 1101 is coupled to the processor 1102 and may be configured to store programs and data necessary for the communication apparatus 1100 to implement various functions. The processor 1102 is configured to support the communication apparatus 1100 to perform corresponding functions in the above methods, and the functions may be implemented by invoking a program stored in the memory 1101. The transceiving component 1103 may be a wireless transceiver, which may be configured to support the communication apparatus 1100 to, through a wireless air interface, receive signaling and/or data and to send signaling and/or data. The transceiving component 1103 may also be called a transceiver unit or a communication unit. The transceiving component 1103 may include a radio frequency component 1104 and one or more antennas 1105. The radio frequency component 1104 may be a remote radio unit (RRU). Specifically, it can be used for the transmission of radio frequency signals and conversion of radio frequency signals and baseband signals. The one or more antennas 1105 may be specifically used for radiating and receiving radio frequency signals.

When the communication apparatus 1100 needs to send data, the processor 1102 may perform baseband processing on the data to be sent, and then output a baseband signal to the radio frequency unit. The radio frequency unit performs radio frequency processing on the baseband signal and then sends a radio frequency signal in the form of electromagnetic waves through an antenna. When data is sent to the communication apparatus 1100, the radio frequency unit receives the radio frequency signal through an antenna, converts the radio frequency signal into a baseband signal, and outputs the baseband signal to the processor 1102. The processor 1102 converts the baseband signal into data and processes the data.

Other implementations of the embodiments of the present disclosure will be readily apparent to those skilled in the art from consideration of the specification and practice of the invention disclosed herein. This application is intended to cover any variations, uses, or adaptations of the embodiments of the present disclosure that follow the general principles of the embodiments of the present disclosure and include common general knowledge or conventional technical means in this art that is not disclosed herein. It is intended that the specification and examples be considered as exemplary only, with a true scope and spirit of the embodiments of the present disclosure being indicated by the appended claims.

It is to be understood that the embodiments of the present disclosure are not limited to the precise structures described above and illustrated in the accompanying drawings, and various modifications and changes may be made without departing from the scope thereof. The scope of the embodiments of the present disclosure is limited only by the appended claims.

### Industrial Applicability

The user equipment timely reports the capability indication information including a reception capability and/or a measurement capability to the network device, so that the network device allocates reasonable scheduling and configuration to the user equipment based on the capability (capabilities) of the user equipment, thereby improving the processing capability of the user equipment.

1. A measurement method, performed by a user equipment, the method comprising:
sending capability indication information to a network device, wherein the capability indication information indicates at least one of a reception capability or a measurement capability; and
receiving measurement configuration information, wherein the measurement configuration information is determined by the network device based on the capability indication information and indicates configuration information for the user equipment to measure a Sounding Reference Signal (SRS) of an interferer device.

2. The method according to claim 1, wherein the capability indication information comprises first information, and the first information is: when Subcarrier Spacing (SCS) of a Physical Downlink Channel (PDCH) configured by a serving cell of the user equipment is different from SCS of the SRS of the interferer device, whether it is supported to simultaneously receive the PDCH and measure the SRS of the interferer device.

3. The method according to claim 1, wherein the capability indication information comprises second information, and the second information is: whether a measurement gap is supported, and the measurement gap is used for measuring the SRS of the interferer device.

4. The method according to claim 3, wherein in response to that the second information corresponds that the measurement gap is supported and the SRS of the interferer device is not within an active Bandwidth Part (BWP) of the serving cell, the measurement configuration information comprises measurement gap configuration information, wherein the measurement gap configuration information indicates the measurement gap used when measuring the SRS of the interferer device; and the method further comprises:
measuring, by the user equipment, the SRS of the interferer device using the measurement gap.

5. The method according to claim 1, wherein in response to that a downlink reference signal of a serving cell of the user equipment and the SRS of the interferer device completely or partially overlap in a time domain, the measurement configuration information comprises time domain proportion configuration information, wherein the time domain proportion configuration information comprises: a first proportion for measuring the downlink reference signal of the serving cell of the user equipment and a second proportion for measuring the SRS of the interferer device; and the method further comprises:
measuring, by the user equipment, the downlink reference signal of the serving cell of the user equipment using the first proportion, and measuring the SRS of the interferer device using the second proportion.

6. The method according to claim 5, wherein a sum of the first proportion and the second proportion is 1.

7. The method according to claim 1, wherein in response to that a downlink reference signal of a serving cell of the user equipment and the SRS of the interferer device completely or partially overlap in a time domain, the measurement configuration information comprises information which indicates prioritized measurement of the downlink reference signal of the serving cell of the user equipment in a preset time period; and the method further comprises:
performing prioritized measurement of the downlink reference signal of the serving cell of the user equipment in the preset time period by the user equipment.

8. The method according to claim 1, wherein in response to that a downlink reference signal of a serving cell of the user equipment and the Sounding Reference Signal (SRS) of the interferer device completely or partially overlap in a time domain, the measurement configuration information comprises information which indicates prioritized measurement of the SRS of the interferer device in a preset time period; and the method further comprises:
performing prioritized measurement of the SRS of the interferer device in the preset time period by the user equipment.

9. The method according to claim 1, wherein in response to that a downlink reference signal of a serving cell of the user equipment and the SRS of the interferer device completely or partially overlap in a time domain, the measurement configuration information comprises priority indication information, wherein the priority indication information indicates a priority of the downlink reference signal of the serving cell of the user equipment and a priority of the SRS of the interferer device; and the method further comprises:
performing prioritized measurement of one of the downlink reference signal or the SRS that corresponds to a highest priority in the priority indication information in a preset time period by the user equipment.

10. The method according to claim 1, wherein measuring the SRS of the interferer device comprises:
measuring at least one of Sounding Reference Signal-Reference Signal Receiving Power (SRS-RSRP) or Cross Link Interference-Received Signal Strength Indication (CLI-RSSI) of the interferer device.

11. A measurement method, performed by a network device, the method comprising:
receiving capability indication information sent by a user equipment, wherein the capability indication information indicates at least one of a reception capability or a measurement capability;
determining measurement configuration information based on the capability indication information; and
sending the measurement configuration information to the user equipment, wherein the measurement configuration information indicates configuration information for the user equipment to measure a Sounding Reference Signal (SRS) of an interferer device.

12. The method according to claim 11, wherein the capability indication information comprises first information, and the first information is: when Subcarrier Spacing (SCS) of a Physical Downlink Channel (PDCH) configured by a serving cell of the user equipment is different from SCS of the SRS of the interferer device, whether it is supported to simultaneously receive the PDCH and measure the SRS of the interferer device.

13. The method according to claim 11, further comprising one of:
in response to that the first information corresponds to that it is supported to simultaneously receive a Physical Downlink Channel (PDCH) and measure the SRS of the interferer device, scheduling the PDCH during a measurement time period for the user equipment to measure the SRS of the interferer device;
in response to the first information corresponds that it is not supported to simultaneously receive the PDCH and measure the SRS of the interferer device, not scheduling the PDCH during the measurement time period for the user equipment to measure the SRS of the interferer device; or
in response to that the first information corresponds to that it is not supported to simultaneously receive the PDCH and measure the SRS of the interferer device, not scheduling the PDCH during an extended time period of the measurement time period for the user equipment to measure the SRS of the interferer device.

14. The method according to claim 13, wherein the extended time period is a time domain region from N symbols before the measurement time period to M symbols after the measurement time period, and the N and the M are the same or different.

15. The method according to claim 11, wherein the capability indication information comprises second information, and the second information is: whether a measurement gap is supported, and the measurement gap is used for measuring the SRS of the interferer device.

16. The method according to claim 15, wherein:
in response to that the second information corresponds to that the measurement gap is supported and the SRS of the interferer device is not within an active Bandwidth Part (BWP) of a serving cell, the measurement configuration information comprises measurement gap configuration information, wherein the measurement gap configuration information indicates the measurement gap used when measuring the SRS of the interferer device; or
in response to that the second information corresponds to that the measurement gap is not supported, the measurement configuration information does not comprise the measurement gap configuration information.

17-39. (canceled)

40. A user equipment, comprising:
a processor; and
a memory storing computer programs;
wherein the processor is configured to:
send capability indication information to a network device, wherein the capability indication information indicates at least one of a reception capability or a measurement capability; and
receive measurement configuration information, wherein the measurement configuration information is determined by the network device based on the capability indication information and indicates configuration information for the user equipment to measure a Sounding Reference Signal (SRS) of an interferer device.

41. A network device, comprising:
a processor; and
a memory storing computer programs;
wherein the processor is configured to perform the method according to claim 11.

42. A non-transitory computer-readable storage medium storing instructions that, when executed by a processor, the processor is caused to implement the method according to claim 1.

43. A non-transitory computer-readable storage medium storing instructions that, when executed by a processor, the processor is caused to implement the method according to claim 11.
